(19) United States
(12) Patent Application Publication
(10) Pub. No.: US 2025/0185062 A1
(43) Pub. Date: Jun. 5, 2025

(54) ENHANCED DISTRIBUTED CHANNEL ACCESS (EDCA) FOR COORDINATED CHANNEL ACCESS

(71) Applicant: QUALCOMM Incorporated, San Diego, CA (US)

(72) Inventors: Sai Yiu Duncan HO, San Diego, CA (US); Abhishek Pramod PATIL, San Diego, CA (US); George CHERIAN, San Diego, CA (US); Alfred ASTERJADHI, San Diego, CA (US); Gaurang NAIK, San Diego, CA (US)

(21) Appl. No.: 18/525,716

(22) Filed: Nov. 30, 2023

(51) Int. Cl. H04W 74/0816; H04W 74/04; H04W 74/08

(52) U.S. Cl. CPC H04W 74/0816; H04W 74/0866; H04W 74/04

(57) ABSTRACT

This disclosure provides methods, components, devices, and systems for enhanced data channel access (EDCA) for coordinated channel access. Some aspects more specifically relate to EDCA prioritization for accessing a wireless channel during restricted target wakeup time (rTWT) service periods (SPs). For example, a first wireless device may receive an indication of EDCA parameters defined for the first wireless device with respect to an rTWT SP of a second wireless device. In such examples, the first wireless may contend for access to a wireless channel during the rTWT SP of the second wireless device using the EDCA parameters according to the received indication. In some implementations, the second wireless device may broadcast a beacon including the EDCA parameters. In some other implementations, the second wireless device may transmit one or more rTWT negotiation messages including the EDCA parameters defined for the first wireless device.

### TECHNICAL FIELD

This disclosure relates generally to wireless communication and, more specifically, to enhanced distributed channel access (EDCA) for coordinated channel access.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a first AP may contend for access to a wireless channel during a restricted target wake time (rTWT) service period (SP) of a second AP, which may lead to transmission collisions between the first AP and the second AP.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a first wireless device. The first wireless device may include a processing system that includes processor circuitry and memory circuitry that stores code. The processing system may be configured to cause the first wireless device to receive one or more EDCA parameters associated with a rTWT SP of a second wireless device and communicate with one or more third wireless devices during the rTWT SP of the second wireless device according to the one or more EDCA parameters.

Another innovative aspect of the subject matter described in this disclosure can be implemented in a method for wireless communication at a first wireless device. The method may include receiving one or more enhanced distributed channel access (EDCA) parameters associated with a restricted target wakeup time (rTWT) service period (SP) of a second wireless device and communicating with one or more third wireless devices during the rTWT SP of the second wireless device according to the one or more EDCA parameters.

Another innovative aspect of the subject matter described in this disclosure can be implemented in another apparatus for wireless communication at a first wireless device. The first wireless device may include means for receiving one or more EDCA parameters associated with a rTWT SP of a second wireless device and means for communicating with one or more third wireless devices during the rTWT SP of the second wireless device according to the one or more EDCA parameters.

Another innovative aspect of the subject matter described in this disclosure can be implemented in a non-transitory computer-readable medium storing code for wireless communication at a first wireless device. The code may include instructions executable by one or more processors to receive one or more EDCA parameters associated with a rTWT SP of a second wireless device and communicate with one or more third wireless devices during the rTWT SP of the second wireless device according to the one or more EDCA parameters.

In some examples of the method, first wireless devices, and non-transitory computer-readable medium described herein, receiving the one or more EDCA parameters may include operations, features, means, or instructions for receiving, from the second wireless device, a beacon that includes the one or more EDCA parameters, where communicating during the rTWT SP of the second wireless may be in accordance with the received beacon.

In some examples of the method, first wireless devices, and non-transitory computer-readable medium described herein, receiving the one or more EDCA parameters may include operations, features, means, or instructions for receiving, from the second wireless device, an advertisement of the rTWT SP of the second wireless device, where the advertisement associates the one or more EDCA parameters with the first wireless device with respect to the rTWT SP of the second wireless device.

In some examples of the method, first wireless devices, and non-transitory computer-readable medium described herein, a use of the one or more EDCA parameters by the first wireless device during the rTWT SP of the second wireless device may be conditioned on an orthogonality between the rTWT SP of the second wireless device and an rTWT SP of the first wireless device.

Some examples of the method, first wireless devices, and non-transitory computer-readable medium described herein may further include operations, features, means, or instructions for transmitting one or more rTWT negotiation messages to the second wireless device, the one or more rTWT negotiation messages including one or more EDCA parameters associated with a rTWT SP of the first wireless device.

Another innovative aspect of the subject matter described in this disclosure can be implemented in another apparatus for wireless communication at a first wireless device. The first wireless device may include a processing system that includes processor circuitry and memory circuitry that stores code. The processing system may be configured to cause the first wireless device to transmit, to a second wireless device, one or more first EDCA parameters associated with a rTWT SP of the first wireless device and communicate with one or more third wireless devices during the rTWT SP of the first wireless device according to one or more second EDCA parameters associated with the first wireless device, the one or more second EDCA parameters being different from the one or more first EDCA parameters.

Another innovative aspect of the subject matter described in this disclosure can be implemented in a method for wireless communication at a first wireless device. The method may include transmitting, to a second wireless device, one or more first EDCA parameters associated with a rTWT SP of the first wireless device and communicating with one or more third wireless devices during the rTWT SP of the first wireless device according to one or more second EDCA parameters associated with the first wireless device, the one or more second EDCA parameters being different from the one or more first EDCA parameters.

Another innovative aspect of the subject matter described in this disclosure can be implemented in another apparatus for wireless communication at a first wireless device. The first wireless device may include means for transmitting, to a second wireless device, one or more first EDCA parameters associated with a rTWT SP of the first wireless device and means for communicating with one or more third wireless devices during the rTWT SP of the first wireless device according to one or more second EDCA parameters associated with the first wireless device, the one or more second EDCA parameters being different from the one or more first EDCA parameters.

Another innovative aspect of the subject matter described in this disclosure can be implemented for wireless communication in another non-transitory computer-readable medium storing code at a first wireless device. The code may include instructions executable by one or more processors to transmit, to a second wireless device, one or more first EDCA parameters associated with a rTWT SP of the first wireless device and communicate with one or more third wireless devices during the rTWT SP of the first wireless device according to one or more second EDCA parameters associated with the first wireless device, the one or more second EDCA parameters being different from the one or more first EDCA parameters.

In some examples of the method, first wireless devices, and non-transitory computer-readable medium described herein, transmitting the one or more first EDCA parameters may include operations, features, means, or instructions for broadcasting a beacon including the one or more first EDCA parameters.

In some examples of the method, first wireless devices, and non-transitory computer-readable medium described herein, transmitting the one or more first EDCA parameters may include operations, features, means, or instructions for transmitting an advertisement of the rTWT SP of the first wireless device, where the advertisement associates the one or more first EDCA parameters with the second wireless device with respect to the rTWT SP of the first wireless device.

Some examples of the method, first wireless devices, and non-transitory computer-readable medium described herein may further include operations, features, means, or instructions for communicating during the rTWT SP of the first wireless device according to the one or more second EDCA parameters may be in accordance with an orthogonality between the rTWT SP of the first wireless device and an rTWT SP of the second wireless device.

In some examples of the method, first wireless devices, and non-transitory computer-readable medium described herein, transmitting the one or more EDCA parameters may include operations, features, means, or instructions for transmitting one or more rTWT negotiation messages to the second wireless device, the one or more rTWT negotiation messages including the one or more first EDCA parameters associated with the rTWT SP of the first wireless device.

Some examples of the method, first wireless devices, and non-transitory computer-readable medium described herein may further include operations, features, means, or instructions for receiving one or more rTWT negotiation messages from the second wireless device, the one or more rTWT negotiation messages including an indication of one or more EDCA parameters associated with a rTWT SP of the second wireless device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2A-2C show examples of signaling diagrams that support enhanced distributed channel access (EDCA) for coordinated channel access.

FIG. 3 shows an example of a process flow that supports EDCA for coordinated channel access.

FIG. 4 shows a block diagram of an example wireless communication device that supports EDCA for coordinated channel access.

FIGS. 5 and 6 show flowcharts illustrating example processes performable by or at a first wireless device that supports EDCA for coordinated channel access.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication and more particularly to prioritized channel access. Some aspects more specifically relate to enhanced distributed channel access (EDCA) prioritization for accessing a wireless channel during restricted target wakeup time (rTWT) service periods (SPs). For example, a first wireless device may receive one or more EDCA parameters associated with an rTWT SP of a second wireless device. In such examples, the first wireless may communicate with one or more third wireless devices during the rTWT SP of the second wireless device according to the one or more EDCA parameters. For example, the first wireless device may contend for, and gain access to, a wireless channel during the rTWT SP of the second wireless device using the EDCA parameters. In some implementations, the first wireless device may monitor for a beacon from the second wireless device, where the beacon may include the one or more EDCA parameters. In some other implementations, the first wireless device may receive an advertisement of the rTWT SP, where the advertisement includes the one or more EDCA parameters associated with the rTWT SP of the second wireless device. Additionally, or alternatively, the first wireless device may receive one or more rTWT negotiation messages including the one or more EDCA parameters associated with the rTWT SP of the second wireless device.

Particular aspects of the subject matter described in this disclosure can be implemented to realize one or more of the following potential advantages. By providing the first wireless device with EDCA parameters defined with respect to the rTWT SP of the second wireless device, aspects of the present disclosure may improve coordination between the first wireless device and the second wireless device, resulting in a reduction of transmission collisions on the wireless channel during the rTWT SP. Additionally, by specifying the EDCA parameters to be used by neighboring devices during an rTWT SP, the second wireless device may have priority to the wireless channel, thereby reducing latency associated with communicating during the rTWT SP. By allowing the first wireless device to contend for the wireless channel during the rTWT of the second wireless device, some aspects provide for efficient utilization of resources, leading to a decrease in latency for communications by the first wireless device. By increasing the efficiency of resource utilization and decreasing the latency in communications, the first wireless device and the second wireless device may achieve a balance between energy savings, link quality, and/or data rates and fair access to the wireless channel via contention. In accordance with such a balance between energy savings, link quality, and/or data rates with fair access to the wireless channel, the subject matter of this disclosure may be further implemented to realize greater reliability, higher data rates, greater spectral efficiency, and greater system capacity, among other benefits.

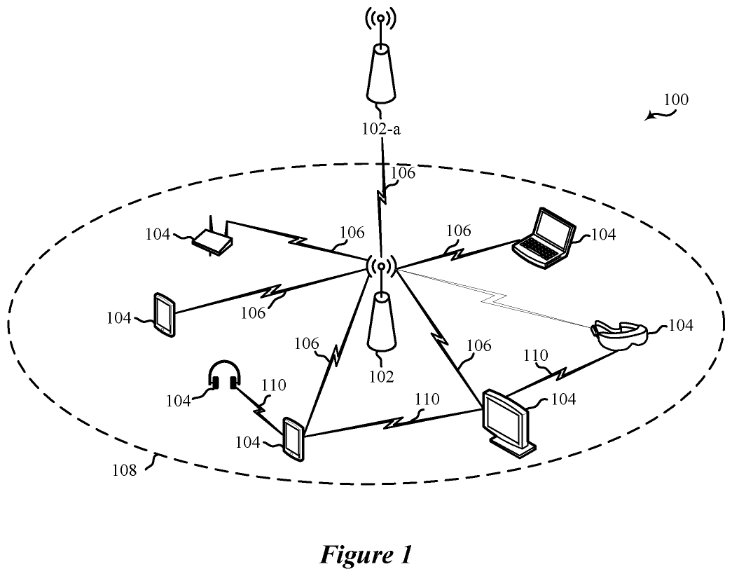

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as, TVs, computer monitors or video gaming consoles), video game controllers, navigation systems, music or other audio or stereo devices, remote control devices, printers, kitchen appliances (including smart refrigerators) or other household appliances, key fobs (such as, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Further, as described herein, the terms “channel” and “subchannel” may be used interchangeably, and each may refer to a portion of a frequency spectrum via which communication between two or more wireless communication devices can be allocated. For example, a channel or subchannel may refer to a discrete portion (such as a discrete amount, span, range, or subset) of frequency of an operating bandwidth. A channel or subchannel may refer to a 20 MHz portion, a 40 MHz portion, an 80 MHz portion, or a 160 MHz portion, among other examples. In other words, a channel or subchannel may include one or more 20 MHz channels. A primary channel or subchannel may be understood as a portion of a frequency spectrum that includes a primary 20 MHz used for beaconing, among other (management) frame transmissions. A secondary channel or subchannel may be understood as a portion of a frequency spectrum that excludes the primary 20 MHz (or that at least excludes a main primary (M-Primary) channel). In some systems, a secondary channel or subchannel may include an opportunistic primary (O-Primary) channel. A wireless communication device may use an M-Primary channel (such as an M-Primary 20 MHz) for beaconing and/or serving legacy clients and may use an O-Primary channel (such as an O-Primary 20 MHz) for opportunistic access on one or more other channels (such as if the M-Primary channel is busy or occupied).

In some aspects, different portions of a frequency spectrum (such as a 40 MHz portion, an 80 MHz portion, or a 160 MHz portion) may be associated with multiple (20 MHz) subchannels and at least one anchor subchannel. In such aspects, an anchor subchannel may define, indicate, or identify a lowest (20 MHz) subchannel within a given portion of a frequency spectrum. For example, a first anchor subchannel may define, indicate, or identify a lowest 20 MHz subchannel within a secondary 40 MHz bandwidth, a second anchor subchannel may define, indicate, or identify a lowest 20 MHz subchannel within a secondary 80 MHz bandwidth, and a third anchor subchannel may define, indicate, or identify a lowest 20 MHz subchannel within a secondary 160 MHz bandwidth. In some aspects, a wireless communication device may use an anchor subchannel as an O-Primary channel.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as, the AP 102 or the STA 104) may contend for access to the wireless medium of a WLAN in accordance with an EDCA procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs 102 and STAs 104 may implement techniques for spatial reuse that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP. The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs 104.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's 102 acquisition of the TXOP enables communication between one or more additional shared APs 102 and their respective BSSs, subject to appropriate power control and link adaptation. For example, the sharing AP 102 may limit the transmit powers of the selected shared APs such that interference from the selected APs 102 does not prevent STAs 104 104 associated with the TXOP owner from successfully decoding packets transmitted by the sharing AP 102. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs 102 may share at least a portion of a single TXOP obtained by any one of the participating APs 102, such techniques may increase throughput across the BSSs associated with the participating APs 102 and also may achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various implementations may achieve these and other advantages without requiring that the sharing AP 102 or the shared APs 102 be aware of the STAs 104 104 associated with other BSSs, without requiring a preassigned or dedicated master AP 102 or preassigned groups of APs 102, and without requiring backhaul coordination between the APs 102 participating in the TXOP.

In some examples in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs 104) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some implementations, the sharing AP 102 may perform polling of a set of un-managed or non-co-managed APs 102 that support coordinated reuse to identify candidates for future spatial reuse opportunities. For example, the sharing AP 102 may transmit one or more spatial reuse poll frames as part of determining one or more spatial reuse criteria and selecting one or more other APs 102 to be shared APs 102. According to the polling, the sharing AP 102 may receive responses from one or more of the polled APs 102. In some specific examples, the sharing AP 102 may transmit a coordinated AP 102 TXOP indication (CTI) frame to other APs 102 that indicates time and frequency of resources of the TXOP that can be shared. The sharing AP 102 may select one or more candidate APs 102 upon receiving a coordinated AP 102 TXOP request (CTR) frame from a respective candidate AP 102 that indicates a desire by the respective AP 102 to participate in the TXOP. The poll responses or CTR frames may include a power indication, for example, a receive (RX) power or RSSI measured by the respective AP 102. In some other examples, the sharing AP 102 may directly measure potential interference of a service supported (such as UL transmission) at one or more APs 102, and select the shared APs 102 based on the measured potential interference. The sharing AP 102 generally selects the APs 102 to participate in coordinated spatial reuse such that it still protects its own transmissions (which may be referred to as primary transmissions) to and from the STAs 104 in its BSS. The selected APs 102 may be allocated resources during the TXOP as described above.

In some implementations, the AP 102 may be in communication, via a communication link 106, with an AP 102-a (such as a neighboring AP). As such, to avoid transmission collisions during a rTWT SP of the AP 102, the AP 102 may transmit an indication of one or more EDCA parameters associated with the rTWT SP of the AP 102 to the AP 102-a. Accordingly, the AP 102-a may use such EDCA parameters to communicate with one or more client STAs during the rTWT SP of the AP 102. That is, the AP 102 may contend for access to a wireless channel during the rTWT SP of the AP 102 using the one or more EDCA parameters received via the AP 102.

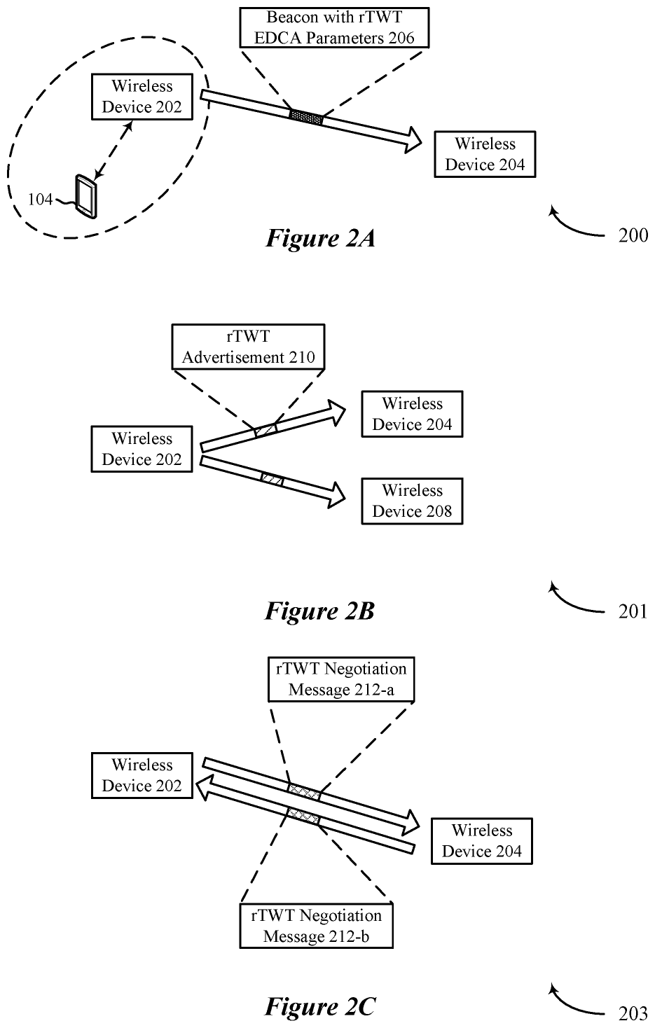

FIG. 2A-2C show examples of signaling diagrams that support EDCA for coordinated channel access. The signaling diagram 200, the signaling diagram 201, and the signaling diagram 203 may implement, or be implemented by, aspects of the wireless communication network 100 with reference to FIG. 1. For example, such signaling diagrams may include a wireless device 202 and a wireless device 204, which in some implementations may be examples of APs 102, as described with reference to FIG. 1. In some other implementations, the wireless device 202 may be an example of an AP 102 as described with reference to FIG. 1, while the wireless device 204 may be an example of a STA 104 as described with reference to FIG. 1 and associated with the AP 102. The techniques described in the context of the signaling diagrams may enable the wireless device 202 to provide an indication of EDCA parameters defined for the wireless device 204 with respect to an rTWT SP of the wireless device 202.

The wireless device 202 may utilize rTWT SPs to communicate latency sensitive traffic to one or more STAs 104. An rTWT SP may be a period of time during which the wireless device 202 has priority to the wireless channel. For example, during an rTWT SP for the wireless device 202, the one or more STAs 104 communicating under the coverage area of the wireless device 202 may cease respective transmission opportunities, such that the wireless device 202 may have priority to the wireless channel. In this way, during the rTWT SP, the wireless device 202 may have enhanced medium access protection and resource reservation on the wireless channel, thereby achieving a more predictable latency and higher reliability for latency sensitive traffic.

To avoid collisions between transmissions from each STA 104 on a wireless channel, each of the one or more STAs 104 may contend for access to the wireless channel according to respective EDCA parameters received from the wireless device 202 (via a beacon). Such EDCA parameters may define a waiting time during which the STAs 104 monitor the channel before transmitting data (such as an arbitration interframe space), a minimum and maximum time window during which the respective STAs 104 may contend for the channel, backoff values associated with monitoring and contending for the channel, a maximum time during which the STAs 104 have the ability to transmit on the channel (such as a transmission opportunity), or any combination thereof. As such, the one or more STAs 104 may use such EDCA parameters to contend for access to the wireless channel and communicate with the wireless device 202.

Accordingly, when the wireless device 202 has an rTWT SP, it may be desirable for the wireless device 202 to gain access to the transmission opportunity with a relatively higher probability at the beginning of the rTWT SP. In some implementations, however, the wireless device 202 may operate in a network that is in close proximity (such as close enough to communicate, interfere with, or receive interference from) to one or more neighboring APs, such as the wireless device 204, without a centralized control node. In such examples, the wireless device 204 may contend for the wireless channel during the rTWT SP of the wireless device 202, leading to collisions and interference between the transmissions of the wireless device 202 and the wireless device 204. Such collisions may increase latency and degrade communications in the network. As such, it may be beneficial for the wireless device 202 and the wireless device 204 (such as a neighboring AP) to coordinate aspects of the rTWT SPs in order to reduce collisions between transmissions of the wireless device 202 and the wireless device 204.

In accordance with the techniques described herein, the wireless device 202 may indicate EDCA parameters defined (specified, recommended, or required) for the wireless device 204 to use during the rTWT SP of the wireless device 202. As such, the wireless device 204 may contend for access to the wireless channel during the rTWT SP of the second wireless device using such defined EDCA parameters, thereby enabling the wireless device 204 to communicate with one or more client STAs 104 during the rTWT SP of the wireless device 202. In some implementations, the wireless device 202 may indicate such EDCA parameters via a beacon 206. Such techniques may be further described herein with reference to FIG. 2A. In some other implementations, the wireless device 202 may transmit an rTWT advertisement 210 indicating such EDCA parameters to the wireless device 204. Such techniques may be further described herein with reference to FIG. 2B. In some implementations, the wireless device 202 and the wireless device 204 may negotiate EDCA parameters for respective rTWT SPs via rTWT negotiation messages 212. Such techniques may be further described herein with reference to FIG. 2C.

In this way, by providing the first wireless device with EDCA parameters defined with respect to the rTWT SP of the second wireless device, the first wireless device and the second wireless device may improve coordination during rTWT SPs, resulting in a reduction of transmission collisions on the wireless channel.

The techniques described in the context of FIG. 2A may enable the wireless device 204 (neighboring AP 102) to receive an indication of the rTWT SP and associated EDCA parameters via the beacon 206. As described herein, the wireless device 202 may broadcast the beacon 206 that includes information associated with the rTWT SP and also includes the one or more EDCA parameters associated with the rTWT SP of the wireless device 202. Accordingly, the wireless device 204 (a neighboring AP 102) may monitor for the beacon 206 and identify the rTWT SP of the wireless device 202 and the associated one or more EDCA parameters to use during the rTWT SP of the wireless device 202.

That is, the wireless device 202 may broadcast the beacon 206 that includes the one or more EDCA parameters defined for the wireless device 204 with respect to the rTWT of the wireless device 202. The wireless device 204 may use the one or more EDCA parameters, received via the beacon 206, to contend for access to the wireless channel during the rTWT SP of the wireless device 202, as if the wireless device 204 (neighboring AP 102) is one of the client STAs 104 associated with the wireless device 202. Accordingly, the wireless device 204, in some implementations, may communicate with one or more client STAs 104 during the rTWT SP of the wireless device 202. In this way, the wireless device 204 may receive an indication of the rTWT SP and associated EDCA parameters by monitoring for the beacon 206 of the wireless device 202, thereby improving coordination between the devices and reducing the transmission collisions during the rTWT SP of the wireless device 202.

In some implementations, the wireless device 202 may indicate, via an extended rTWT element of the beacon 206, one or more first EDCA parameters defined for the STA 104 with respect to a particular rTWT SP of the wireless device 202. The wireless device 202 also may indicate, via a separate information element of the beacon 206, one or more second EDCA parameters defined for the STA 104 to use when outside the rTWT SP of the wireless device 202. That is, the wireless device 202 may define separate EDCA parameters for in-BSS STAs 104, where the one or more first EDCA parameters may be associated with an rTWT SP of the wireless device 202 and the one or more second EDCA parameters may be associated with periods of time outside of the rTWT SP (such as before or after the rTWT SP).

As such, during the rTWT SP of the wireless device 202, the STA 104 may contend for access to the wireless channel using the one or more first EDCA parameters. Similarly, when outside of the rTWT SP, the STA 104 may contend for access to the wireless channel using the one or more second EDCA parameters. Additionally, the wireless device 202 may include various other communication parameters (in-BSS access parameters) via the extended rTWT information element of the beacon.

In such implementations, the wireless device 202 may generate the one or more first EDCA parameters for the wireless device 204 (client STA 104) to use during the rTWT SP of the wireless device 202, where such EDCA parameters may have less priority (such as larger waiting time, smaller contention windows, or smaller transmission opportunity) as compared to the one or more second EDCA parameters used by the STA 104 when outside the rTWT SP of the wireless device 202. In this way, the wireless device 202 may have priority to the wireless channel during the rTWT SP.

In some implementations, the wireless device 202 may define different EDCA parameters for use by member STAs 104 and non-member STAs 104 and indicate such parameters via an extended rTWT information element of the beacon 206. For example, the wireless device 202 may indicate, via the beacon 206, one or more first EDCA parameters defined for member STAs 104 with respect to the rTWT SP of the wireless device 202, one or more second EDCA parameters defined for non-member STAs 104 with respect to the rTWT SP of the wireless device 202, and one or more third EDCA parameters defined for STAs 104 (both member and non-members) with respect to communications outside of the rTWT SP of the wireless device 202. In such implementations, a member STA 104 may contend for access to the wireless channel using the one or more first EDCA parameters during the rTWT SP and contend for access to the wireless channel using the one or more third EDCA parameters when outside of the rTWT SP of the wireless device 202. Similarly, a non-member STA 104 may contend for access to the wireless channel using the one or more second EDCA parameters during the rTWT SP of the wireless device 202 and contend for access to the wireless channel using the one or more third EDCA parameters when outside of the rTWT SP of the wireless device 202.

The techniques described in the context of the signaling diagram 201 of FIG. 2B may enable the wireless device 202 to indicate AP-specific EDCA parameters defined via rTWT advertisement 210, which may be an example of the beacon 206. For example, the wireless device 202 may include, via the rTWT advertisement 210, one or more first EDCA parameters defined for the wireless device 204 (neighboring APs) with respect to the rTWT SP of the wireless device 202, in addition to including one or more second EDCA parameters (baseline EDCA parameters) defined for the one or more STAs 104 with respect to the rTWT SP of the wireless device 202. As such, the wireless device 204 may use the one or more first EDCA parameters to contend for access to the wireless channel during the rTWT SP of the wireless device 202, while the one or more STAs 104 associated with (under the coverage of) the wireless device 202 may use the one or more second EDCA parameters to contend for access to the wireless channel.

For example, the wireless device 202 may indicate, via an rTWT information element of the rTWT advertisement 210, the one or more first EDCA parameters defined for the wireless device 204 (and other neighboring APs), where the rTWT information element also may include scheduling information associated with the rTWT SP of the wireless device 202. Additionally, the wireless device 202 may include, via a separate information element of the rTWT advertisement 210, the one or more second EDCA parameters defined for associated STAs 104. Accordingly, the wireless device 204 may receive the rTWT advertisement 210 and identify the one or more first EDCA parameters from the rTWT information element of the beacon, while a STA 104 associated with the wireless device 202 may identify the one or more second EDCA parameters from the rTWT advertisement 210.

In some implementations, the wireless device 202 may advertise, via the rTWT advertisement 210, rTWT information associated with neighboring APs, such as, by including the rTWT information element and corresponding EDCA parameters of each neighboring AP in the rTWT advertisement 210. That is, the wireless device 202 may include additional EDCA parameters associated with a wireless device 208 (such as an additional neighboring AP) with respect to the rTWT SP of the wireless device 202.

As an illustrative example, the wireless device 202 may operate in a network with multiple neighboring APs, such as the wireless device 204 and the wireless device 208. In such examples, the wireless device 202 may transmit, via the rTWT information element of the rTWT advertisement 210, one or more first EDCA parameters defined for the wireless device 204 and one or more second EDCA parameters defined for the wireless device 208. Additionally, the wireless device 204 may indicate, via the rTWT advertisement 210, one or more EDCA parameters defined for the one or more STAs 104 associated with the wireless device 202. In such examples, the wireless device 204 may contend for the wireless channel during the rTWT SP of the wireless device 202 using the one or more first EDCA parameters, while the wireless device 208 may contend for the wireless channel during the rTWT SP of the wireless device 202 using the one or more second EDCA parameters.

In some implementations, the one or more first EDCA parameters defined for the wireless device 204 (for neighboring APs) may apply when the rTWT SP of the wireless device 202 is orthogonal (does not overlap in time) with an rTWT SP of the wireless device 204. That is, the use of the one or more first EDCA parameters by the wireless device 204 may be conditioned on an orthogonality between the rTWT SP of the wireless device 202 and the rTWT SP of the wireless device 204.

Accordingly, if the rTWT SP of the wireless device 202 overlaps with the rTWT SP of the wireless device 204 (in time, as in the implementation of coordinated spatial reuse), the wireless device 202 and the wireless device 204 may independently perform medium access, such as contend for the wireless channel, using respective EDCA parameters. In such implementations, the wireless device 202 and the wireless device 204 may apply other parameters, such as max transmission power, while contending for the wireless channel during overlapping rTWT SPs to avoid transmission collisions and interference.

The techniques described in the context of the signaling diagram 203 of FIG. 2C may enable the wireless device 202 and the wireless device 204 to negotiate respective EDCA parameters for respective rTWT SPs. That is, the wireless device 202 and the wireless device 204 (neighboring APs 102) may support coordinated rTWT (C-rTWT) negotiation, in which the wireless device 202 and the wireless device 204 may exchange respective EDCA parameters for respective rTWT SPs via rTWT negotiation messages 212.

For example, the wireless device 202 may transmit an rTWT negotiation message 212-a including one or more EDCA parameters defined for the wireless device 204 with respect to the rTWT SP of the wireless device 202. Additionally, the wireless device 204 may transmit an rTWT negotiation message 212-b indicating one or more EDCA parameters defined for the wireless device 202 with respect to the rTWT SP of the wireless device 204. In some implementations, the wireless device 202 may include scheduling information related to the rTWT of the wireless device 202 via the rTWT negotiation message 212-a, while the wireless device 204 may include scheduling information related to the rTWT of the wireless device 204 via the rTWT negotiation message 212-b.

Accordingly, during the rTWT SP of the wireless device 202, the wireless device 204 may use the one or more EDCA parameters received via the rTWT negotiation message 212-a to contend for the wireless channel. Similarly, during the rTWT SP of the wireless device 204, the wireless device 202 may use the one or more EDCA parameters received via the rTWT negotiation message 212-b to contend for access to the wireless channel. In this way, the wireless device 202 and the wireless device 204 may exchange respective EDCA parameters for respective rTWT SPs via the rTWT negotiation messages 212.

In some implementations, the wireless device 202 and the wireless device 204 may negotiate EDCA parameters with respect to the rTWT SP of the wireless device 202. For example, the wireless device 202 may transmit the rTWT negotiation message 212-a indicating the one or more EDCA parameters defined for the wireless device 204 with respect to the rTWT SP of the wireless device 202. In response, the wireless device 204 may transmit, via the rTWT negotiation message 212-b, an indication of updated EDCA parameters with respect to the rTWT SP of the wireless device 202. The wireless device 202 may transmit an additional rTWT negotiation message 212 (not shown) indicating acceptance of the updated EDCA parameters, a reassertion of the original one or more EDCA parameters, or a counter proposal to the updated EDCA parameters. Accordingly, the wireless device 204 may contend for access to the wireless channel using the agreed upon EDCA parameters.

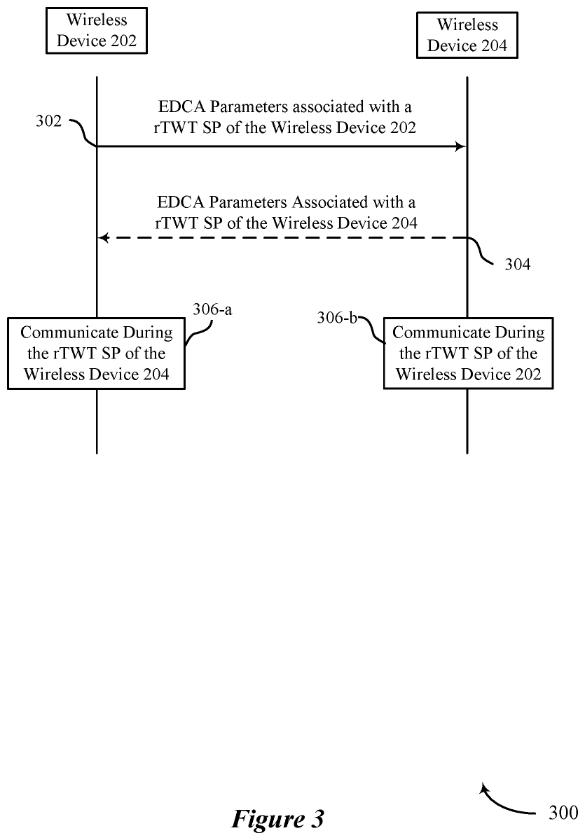

FIG. 3 shows an example of a process flow 300 that supports EDCA for coordinated channel access. The process flow 300 may implement, or be implemented by, aspects of the wireless communication network 100, the signaling diagram 200, the signaling diagram 201, or the signaling diagram 203 with reference to FIGS. 1 and 2. For example, the process flow 300 may include a wireless device 202 and a wireless device 204, which may be examples of the wireless device 202 and the wireless device 204 as described herein with reference to FIGS. 2A-2C.

At 302, the wireless device 202 may transmit one or more EDCA parameters associated with a rTWT SP of the wireless device 202. In some implementations, the wireless device 202 may broadcast a beacon, such as a beacon 206, indicating the one or more EDCA parameters. The wireless device 202 may broadcast the beacon according to the techniques described herein with reference to FIG. 2A.

In some other implementations, the wireless device 202 may transmit an rTWT advertisement, such as the rTWT advertisement 210, associating the one or more EDCA parameters with the rTWT SP of the wireless device 202. The wireless device 202 may transmit the rTWT advertisement according to the techniques described herein with reference to FIG. 2C. In some other implementations, the wireless device 202 may transmit a rTWT negotiation message, such as the rTWT negotiation message 212-a, that indicates the EDCA parameters. The wireless device 202 may transmit the rTWT negotiation message according to the techniques described herein with reference to FIG. 2C.

At 304, if the wireless device 204 receives the one or more EDCA parameters via an rTWT negotiation message, the wireless device 204 may transmit one or more EDCA parameters associated with an rTWT SP of the wireless device 204 according to the techniques described herein with reference to FIG. 2C.

At 306-a, the wireless device 202 may communicate with one or more third wireless devices, such as client STAs 104, according to one or more second EDCA parameters associated with the wireless device 202, where the one or more second EDCA parameters may be different than the one or more EDCA parameters indicated to the wireless device 204. For example, the one or more second EDCA parameters may have a higher priority, such as a smaller waiting time, larger contention windows, or larger transmission opportunity) than those of the one or more EDCA parameters indicated to the wireless device 204. Accordingly, the wireless device 202 may contend for access to the wireless channel, using the one or more second EDCA parameters, and have a higher probability of accessing the channel than the wireless device 204.

At 306-b, the wireless device 204 ma communicate with one or more third wireless devices, such as client STAs 104, during the rTWT SP of the wireless device 202 according to the one or more EDCA parameters. For example, the wireless device 204 may contend for access to the wireless channel using the one or more EDCA parameters. As such, if the wireless device 202 has completed, or is not using, the wireless channel during the rTWT SP, the wireless device 204 may access the wireless channel and communicate with one or more client STAs 104 during the rTWT SP of the wireless device 202.

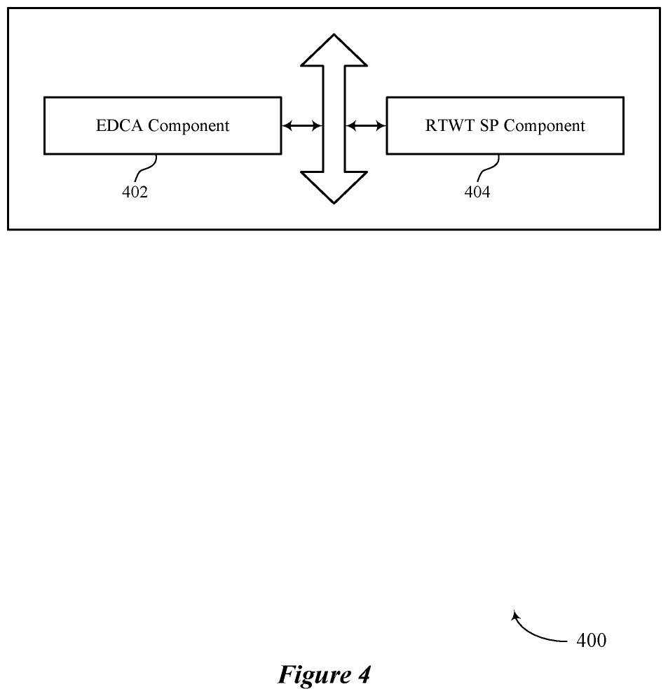

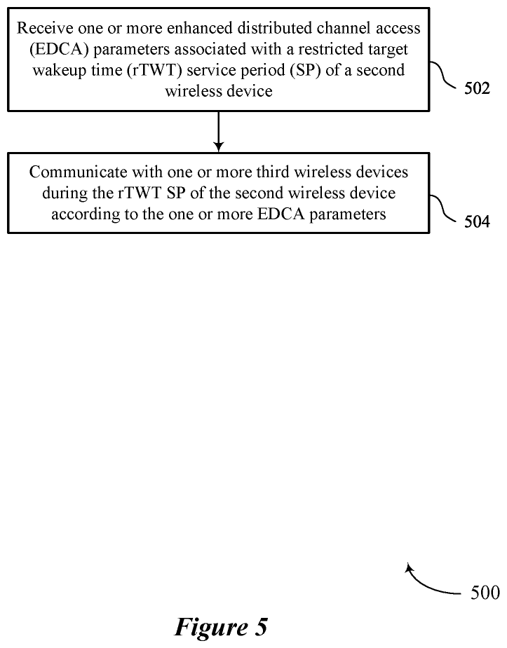

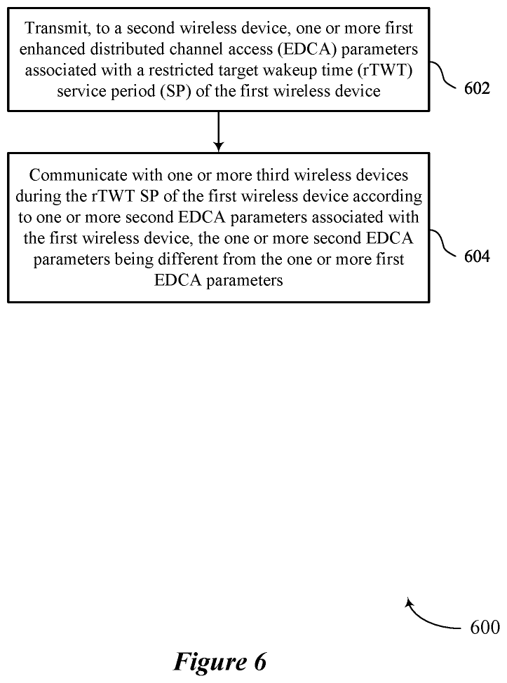

FIG. 4 shows a block diagram of an example wireless communication device 400 that supports EDCA for coordinated channel access. In some implementations, the wireless communication device 400 is configured to perform the processes 500 and 600 described with reference to FIGS. 5 and 6, respectively. The wireless communication device 400 may include one or more chips, SoCs, chipsets, packages, components or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is passed to the processing system. In some such examples, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as, IEEE compliant) modem or a cellular (such as, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 400 can be configurable or configured for use in an AP, such as the AP 102 described with reference to FIG. 1. In some other examples, the wireless communication device 400 can be an AP that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other examples, the wireless communication device 400 can be configurable or configured to transmit and receive signals and communications conforming to one or more 3GPP specifications including those for 5G NR or 6G. In some implementations, the wireless communication device 400 also includes or can be coupled with one or more application processors which may be further coupled with one or more other memories. In some implementations, the wireless communication device 400 further includes at least one external network interface coupled with the processing system that enables communication with a core network or backhaul network that enables the wireless communication device 400 to gain access to external networks including the Internet.

The wireless communication device 400 includes a EDCA component 402 and a rTWT SP component 404. Portions of one or more of the EDCA component 402 and the rTWT SP component 404 may be implemented at least in part in hardware or firmware. For example, one or more of the EDCA component 402 and the rTWT SP component 404 may be implemented at least in part by at least a processor or a modem. In some implementations, portions of one or more of the EDCA component 402 and the rTWT SP component 404 may be implemented at least in part by a processor and software in the form of processor-executable code stored in memory.

The wireless communication device 400 may support wireless communication in accordance with examples as disclosed herein. The EDCA component 402 is configurable or configured to receive one or more EDCA parameters associated with a rTWT SP of a second wireless device. The rTWT SP component 404 is configurable or configured to communicate with one or more third wireless devices during the rTWT SP of the second wireless device according to the one or more EDCA parameters.

In some implementations, to support receiving the one or more EDCA parameters, the EDCA component 402 is configurable or configured to receive, from the second wireless device, a beacon that includes the one or more EDCA parameters, where communicating during the rTWT SP of the second wireless device is in accordance with the received beacon.

In some implementations, to support receiving the one or more EDCA parameters, the EDCA component 402 is configurable or configured to receive, from the second wireless device, an advertisement of the rTWT SP of the second wireless device, where the advertisement associates the one or more EDCA parameters with the first wireless device with respect to the rTWT SP of the second wireless device.

In some implementations, the advertisement of the rTWT SP of the second wireless device further associates one or more additional EDCA parameters with a fourth wireless device with respect to the rTWT SP of the second wireless device.

In some implementations, a use of the one or more EDCA parameters by the first wireless device during the rTWT SP of the second wireless device is conditioned on an orthogonality between the rTWT SP of the second wireless device and an rTWT SP of the first wireless device.

In some implementations, communicating during the rTWT SP of the second wireless device according to the one or more EDCA parameters is in accordance with an orthogonality between the rTWT SP of the second wireless device and an rTWT SP of the first wireless device.

In some implementations, to support receiving the one or more EDCA parameters, the EDCA component 402 is configurable or configured to receive one or more rTWT negotiation messages from the second wireless device, the one or more RTWT negotiation messages including the one or more EDCA parameters associated with the rTWT SP of the second wireless device.

In some implementations, the EDCA component 402 is configurable or configured to transmit one or more rTWT negotiation messages to the second wireless device, the one or more rTWT negotiation messages including one or more EDCA parameters associated with a rTWT SP of the first wireless device.

In some implementations, the first wireless device is a first wireless AP, and the second wireless device is a second wireless AP.

In some implementations, the first wireless device is a wireless STA, and the second wireless device is a wireless AP.

Additionally, or alternatively, the wireless communication device 400 may support wireless communication in accordance with examples as disclosed herein. In some implementations, the EDCA component 402 is configurable or configured to transmit, to a second wireless device, one or more first EDCA parameters associated with a rTWT SP of the first wireless device. In some implementations, the rTWT SP component 404 is configurable or configured to communicate with one or more third wireless devices during the rTWT SP of the first wireless device according to one or more second EDCA parameters associated with the first wireless device, the one or more second EDCA parameters being different from the one or more first EDCA parameters.

In some implementations, to support transmitting the one or more first EDCA parameters, the EDCA component 402 is configurable or configured to broadcast a beacon including the one or more first EDCA parameters.

In some implementations, to support transmitting the one or more first EDCA parameters, the EDCA component 402 is configurable or configured to transmit an advertisement of the rTWT SP of the first wireless device, where the advertisement associates the one or more first EDCA parameters with the second wireless device with respect to the rTWT SP of the first wireless device.

In some implementations, the advertisement of the rTWT SP of the first wireless device further associates one or more third EDCA parameters with a fourth wireless device with respect to the rTWT SP of the first wireless device.

In some implementations, communicating during the rTWT SP of the first wireless device according to the one or more second EDCA parameters is in accordance with an orthogonality between the rTWT SP of the first wireless device and an rTWT SP of the second wireless device.

In some implementations, to support transmitting the one or more EDCA parameters, the EDCA component 402 is configurable or configured to transmit one or more rTWT negotiation messages to the second wireless device, the one or more rTWT negotiation messages including the one or more first EDCA parameters associated with the rTWT SP of the first wireless device.

In some implementations, the EDCA component 402 is configurable or configured to receive one or more rTWT negotiation messages from the second wireless device, the one or more rTWT negotiation messages including an indication of one or more EDCA parameters associated with a rTWT SP of the second wireless device.

In some implementations, the first wireless device is a first wireless AP, and the second wireless device is a second wireless AP.

In some implementations, the first wireless device is a wireless AP, and the second wireless device is a wireless STA.

FIG. 5 shows a flowchart illustrating an example process 500 performable by or at a first wireless device that supports EDCA for coordinated channel access. The operations of the process 500 may be implemented by a first wireless device or its components as described herein. For example, the process 500 may be performed by a wireless communication device, such as the wireless communication device 400 described with reference to FIG. 4, operating as or within a wireless AP. In some implementations, the process 500 may be performed by a wireless AP, such as one of the APs 022 described with reference to FIG. 1.

In some implementations, at 502, the first wireless device may receive one or more EDCA parameters associated with a rTWT SP of a second wireless device. The operations of 502 may be performed in accordance with examples as disclosed herein. In some implementations, aspects of the operations of 502 may be performed by a EDCA component 402 as described with reference to FIG. 4.

In some implementations, at 504, the first wireless device may communicate with one or more third wireless devices during the rTWT SP of the second wireless device according to the one or more EDCA parameters. The operations of 504 may be performed in accordance with examples as disclosed herein. In some implementations, aspects of the operations of 504 may be performed by a rTWT SP component 404 as described with reference to FIG. 4.

FIG. 6 shows a flowchart illustrating an example process 600 performable by or at a first wireless device that supports EDCA for coordinated channel access. The operations of the process 600 may be implemented by a first wireless device or its components as described herein. For example, the process 600 may be performed by a wireless communication device, such as the wireless communication device 400 described with reference to FIG. 4, operating as or within a wireless AP. In some implementations, the process 600 may be performed by a wireless AP, such as one of the APs 022 described with reference to FIG. 1.

In some implementations, at 602, the first wireless device may transmit, to a second wireless device, one or more first EDCA parameters associated with a rTWT SP of the first wireless device. The operations of 602 may be performed in accordance with examples as disclosed herein. In some implementations, aspects of the operations of 602 may be performed by a EDCA component 402 as described with reference to FIG. 4.

In some implementations, at 604, the first wireless device may communicate with one or more third wireless devices during the rTWT SP of the first wireless device according to one or more second EDCA parameters associated with the first wireless device, the one or more second EDCA parameters being different from the one or more first EDCA parameters. The operations of 604 may be performed in accordance with examples as disclosed herein. In some implementations, aspects of the operations of 604 may be performed by a rTWT SP component 404 as described with reference to FIG. 4.

Implementation examples are described in the following numbered clauses:

The following provides an overview of aspects of the present disclosure:

Aspect 1: A method for wireless communication by a first wireless device, including: receiving one or more EDCA parameters associated with a rTWT SP of a second wireless device; and communicating with one or more third wireless devices during the rTWT SP of the second wireless device according to the one or more EDCA parameters.

Aspect 2: The method of aspect 1, where receiving the one or more EDCA parameters includes: receiving, from the second wireless device, a beacon that includes the one or more EDCA parameters, where communicating during the rTWT SP of the second wireless device is in accordance with the received beacon.

Aspect 3: The method of any of aspects 1 through 2, where receiving the one or more EDCA parameters includes: receiving, from the second wireless device, an advertisement of the rTWT SP of the second wireless device, where the advertisement associates the one or more EDCA parameters with the first wireless device with respect to the rTWT SP of the second wireless device.

Aspect 4: The method of aspect 3, where the advertisement of the rTWT SP of the second wireless device further associates one or more additional EDCA parameters with a fourth wireless device with respect to the rTWT SP of the second wireless device.

Aspect 5: The method of any of aspects 1 through 4, where a use of the one or more EDCA parameters by the first wireless device during the rTWT SP of the second wireless device is conditioned on an orthogonality between the rTWT SP of the second wireless device and an rTWT SP of the first wireless device.

Aspect 6: The method of any of aspects 1 through 5, where communicating during the rTWT SP of the second wireless device according to the one or more EDCA parameters is in accordance with an orthogonality between the rTWT SP of the second wireless device and an rTWT SP of the first wireless device.

Aspect 7: The method of any of aspects 1 through 6, where receiving the one or more EDCA parameters includes: receiving one or more rTWT negotiation messages from the second wireless device, the one or more RTWT negotiation messages including the one or more EDCA parameters associated with the rTWT SP of the second wireless device.

Aspect 8: The method of aspect 7, further including: transmitting one or more rTWT negotiation messages to the second wireless device, the one or more rTWT negotiation messages including one or more EDCA parameters associated with a rTWT SP of the first wireless device.

Aspect 9: The method of any of aspects 1 through 8, where the first wireless device is a first wireless AP, and the second wireless device is a second wireless AP.

Aspect 10: The method of any of aspects 1 through 9, where the first wireless device is a wireless STA, and the second wireless device is a wireless AP.

Aspect 11: A method for wireless communication by a first wireless device, including: transmitting, to a second wireless device, one or more first EDCA parameters associated with a rTWT SP of the first wireless device; and communicating with one or more third wireless devices during the rTWT SP of the first wireless device according to one or more second EDCA parameters associated with the first wireless device, the one or more second EDCA parameters being different from the one or more first EDCA parameters.

Aspect 12: The method of aspect 11, where transmitting the one or more first EDCA parameters includes: broadcasting a beacon including the one or more first EDCA parameters.

Aspect 13: The method of any of aspects 11 through 12, where transmitting the one or more first EDCA parameters includes: transmitting an advertisement of the rTWT SP of the first wireless device, where the advertisement associates the one or more first EDCA parameters with the second wireless device with respect to the rTWT SP of the first wireless device.

Aspect 14: The method of aspect 13, where the advertisement of the rTWT SP of the first wireless device further associates one or more third EDCA parameters with a fourth wireless device with respect to the rTWT SP of the first wireless device.

Aspect 15: The method of any of aspects 11 through 14, where communicating during the rTWT SP of the first wireless device according to the one or more second EDCA parameters is in accordance with an orthogonality between the rTWT SP of the first wireless device and an rTWT SP of the second wireless device.

Aspect 16: The method of any of aspects 11 through 15, where transmitting the one or more EDCA parameters includes: transmitting one or more rTWT negotiation messages to the second wireless device, the one or more rTWT negotiation messages including the one or more first EDCA parameters associated with the rTWT SP of the first wireless device.

Aspect 17: The method of aspect 16, further including: receiving one or more rTWT negotiation messages from the second wireless device, the one or more rTWT negotiation messages including an indication of one or more EDCA parameters associated with a rTWT SP of the second wireless device.

Aspect 18: The method of any of aspects 11 through 17, where the first wireless device is a first wireless AP, and the second wireless device is a second wireless AP.

Aspect 19: The method of any of aspects 11 through 18, where the first wireless device is a wireless AP, and the second wireless device is a wireless STA.

Aspect 20: A first wireless device, including: a processing system that includes processor circuitry and memory circuitry that stores code, the processing system configured to cause the first wireless device to: receive one or more EDCA parameters associated with a rTWT SP of a second wireless device; and communicate with one or more third wireless devices during the rTWT SP of the second wireless device according to the one or more EDCA parameters.

Aspect 21: The first wireless device of aspect 20, where, to receive the one or more EDCA parameters, the processing system is configured to cause the first wireless device to: receive, from the second wireless device, a beacon that includes the one or more EDCA parameters, where communicating during the rTWT SP of the second wireless device is in accordance with the received beacon.

Aspect 22: The first wireless device of any of aspects 20 through 21, where, to receive the one or more EDCA parameters, the processing system is configured to cause the first wireless device to: receive, from the second wireless device, an advertisement of the rTWT SP of the second wireless device, where the advertisement associates the one or more EDCA parameters with the first wireless device with respect to the rTWT SP of the second wireless device.

Aspect 23: The first wireless device of aspect 22, where the advertisement of the rTWT SP of the second wireless device further associates one or more additional EDCA parameters with a fourth wireless device with respect to the rTWT SP of the second wireless device.

Aspect 24: The first wireless device of any of aspects 20 through 23, where a use of the one or more EDCA parameters by the first wireless device during the rTWT SP of the second wireless device is conditioned on an orthogonality between the rTWT SP of the second wireless device and an rTWT SP of the first wireless device.

Aspect 25: The first wireless device of any of aspects 20 through 24, where communicating during the rTWT SP of the second wireless device according to the one or more EDCA parameters is in accordance with an orthogonality between the rTWT SP of the second wireless device and an rTWT SP of the first wireless device.

Aspect 26: The first wireless device of any of aspects 20 through 25, where, to receive the one or more EDCA parameters, the processing system is configured to cause the first wireless device to: receive one or more rTWT negotiation messages from the second wireless device, the one or more RTWT negotiation messages including the one or more EDCA parameters associated with the rTWT SP of the second wireless device.

Aspect 27: The first wireless device of aspect 26, where the processing system is further configured to cause the first wireless device to: transmit one or more rTWT negotiation messages to the second wireless device, the one or more rTWT negotiation messages including one or more EDCA parameters associated with a rTWT SP of the first wireless device.

Aspect 28: The first wireless device of any of aspects 20 through 27, where the first wireless device is a first wireless AP, and the second wireless device is a second wireless AP.

Aspect 29: The first wireless device of any of aspects 20 through 28, where the first wireless device is a wireless STA, and the second wireless device is a wireless AP.

Aspect 30: A first wireless device, including: a processing system that includes processor circuitry and memory circuitry that stores code, the processing system configured to cause the first wireless device to: transmit, to a second wireless device, one or more first EDCA parameters associated with a rTWT SP of the first wireless device; and communicate with one or more third wireless devices during the rTWT SP of the first wireless device according to one or more second EDCA parameters associated with the first wireless device, the one or more second EDCA parameters being different from the one or more first EDCA parameters.

Aspect 31: The first wireless device of aspect 30, where, to transmit the one or more first EDCA parameters, the processing system is configured to cause the first wireless device to: broadcast a beacon including the one or more first EDCA parameters.

Aspect 32: The first wireless device of any of aspects 30 through 31, where, to transmit the one or more first EDCA parameters, the processing system is configured to cause the first wireless device to: transmit an advertisement of the rTWT SP of the first wireless device, where the advertisement associates the one or more first EDCA parameters with the second wireless device with respect to the rTWT SP of the first wireless device.

Aspect 33: The first wireless device of aspect 32, where the advertisement of the rTWT SP of the first wireless device further associates one or more third EDCA parameters with a fourth wireless device with respect to the rTWT SP of the first wireless device.

Aspect 34: The first wireless device of any of aspects 30 through 33, where communicating during the rTWT SP of the first wireless device according to the one or more second EDCA parameters is in accordance with an orthogonality between the rTWT SP of the first wireless device and an rTWT SP of the second wireless device.

Aspect 35: The first wireless device of any of aspects 30 through 34, where, to transmit the one or more EDCA parameters, the processing system is configured to cause the first wireless device to: transmit one or more rTWT negotiation messages to the second wireless device, the one or more rTWT negotiation messages including the one or more first EDCA parameters associated with the rTWT SP of the first wireless device.

Aspect 36: The first wireless device of aspect 35, where the processing system is further configured to cause the first wireless device to: receive one or more rTWT negotiation messages from the second wireless device, the one or more rTWT negotiation messages including an indication of one or more EDCA parameters associated with a rTWT SP of the second wireless device.

Aspect 37: The first wireless device of any of aspects 30 through 36, where the first wireless device is a first wireless AP, and the second wireless device is a second wireless AP.

Aspect 38: The first wireless device of any of aspects 30 through 37, where the first wireless device is a wireless AP, and the second wireless device is a wireless STA.

Aspect 39: A first wireless device for wireless communication, including: means for receiving one or more EDCA parameters associated with a rTWT SP of a second wireless device; and means for communicating with one or more third wireless devices during the rTWT SP of the second wireless device according to the one or more EDCA parameters.

Aspect 40: The first wireless device of aspect 39, where the means for receiving the one or more EDCA parameters include: means for receiving, from the second wireless device, a beacon that includes the one or more EDCA parameters, where communicating during the rTWT SP of the second wireless device is in accordance with the received beacon.

Aspect 41: The first wireless device of any of aspects 39 through 40, where the means for receiving the one or more EDCA parameters include: means for receiving, from the second wireless device, an advertisement of the rTWT SP of the second wireless device, where the advertisement associates the one or more EDCA parameters with the first wireless device with respect to the rTWT SP of the second wireless device.

Aspect 42: The first wireless device of aspect 41, where the advertisement of the rTWT SP of the second wireless device further associates one or more additional EDCA parameters with a fourth wireless device with respect to the rTWT SP of the second wireless device.

Aspect 43: The first wireless device of any of aspects 39 through 42, where a use of the one or more EDCA parameters by the first wireless device during the rTWT SP of the second wireless device is conditioned on an orthogonality between the rTWT SP of the second wireless device and an rTWT SP of the first wireless device.

Aspect 44: The first wireless device of any of aspects 39 through 43, where communicating during the rTWT SP of the second wireless device according to the one or more EDCA parameters is in accordance with an orthogonality between the rTWT SP of the second wireless device and an rTWT SP of the first wireless device.

Aspect 45: The first wireless device of any of aspects 39 through 44, where the means for receiving the one or more EDCA parameters include: means for receiving one or more rTWT negotiation messages from the second wireless device, the one or more RTWT negotiation messages including the one or more EDCA parameters associated with the rTWT SP of the second wireless device.

Aspect 46: The first wireless device of aspect 45, further including: means for transmitting one or more rTWT negotiation messages to the second wireless device, the one or more rTWT negotiation messages including one or more EDCA parameters associated with a rTWT SP of the first wireless device.

Aspect 47: The first wireless device of any of aspects 39 through 46, where the first wireless device is a first wireless AP, and the second wireless device is a second wireless AP.

Aspect 48: The first wireless device of any of aspects 39 through 47, where the first wireless device is a wireless STA, and the second wireless device is a wireless AP.

Aspect 49: A first wireless device for wireless communication, including: means for transmitting, to a second wireless device, one or more first EDCA parameters associated with a rTWT SP of the first wireless device; and means for communicating with one or more third wireless devices during the rTWT SP of the first wireless device according to one or more second EDCA parameters associated with the first wireless device, the one or more second EDCA parameters being different from the one or more first EDCA parameters.

Aspect 50: The first wireless device of aspect 49, where the means for transmitting the one or more first EDCA parameters include: means for broadcasting a beacon including the one or more first EDCA parameters.

Aspect 51: The first wireless device of any of aspects 49 through 50, where the means for transmitting the one or more first EDCA parameters include: means for transmitting an advertisement of the rTWT SP of the first wireless device, where the advertisement associates the one or more first EDCA parameters with the second wireless device with respect to the rTWT SP of the first wireless device.

Aspect 52: The first wireless device of aspect 51, where the advertisement of the rTWT SP of the first wireless device further associates one or more third EDCA parameters with a fourth wireless device with respect to the rTWT SP of the first wireless device.

Aspect 53: The first wireless device of any of aspects 49 through 52, where the means for transmitting the one or more EDCA parameters include: means for transmitting one or more rTWT negotiation messages to the second wireless device, the one or more rTWT negotiation messages including the one or more first EDCA parameters associated with the rTWT SP of the first wireless device.

Aspect 54: The first wireless device of aspect 53, further including: means for receiving one or more rTWT negotiation messages from the second wireless device, the one or more rTWT negotiation messages including an indication of one or more EDCA parameters associated with a rTWT SP of the second wireless device.

Aspect 55: The first wireless device of any of aspects 49 through 54, where the first wireless device is a first wireless AP, and the second wireless device is a second wireless AP.

Aspect 56: The first wireless device of any of aspects 49 through 55, where the first wireless device is a wireless AP, and the second wireless device is a wireless STA.

Aspect 57: A non-transitory computer-readable medium storing code for wireless communication, the code including instructions executable by one or more processors to: receive one or more EDCA parameters associated with a rTWT SP of a second wireless device; and communicate with one or more third wireless devices during the rTWT SP of the second wireless device according to the one or more EDCA parameters.

Aspect 58: The non-transitory computer-readable medium of aspect 57,wherein the code to receive the one or more EDCA parameters are executable by the one or more processors to: receive, from the second wireless device, a beacon that includes the one or more EDCA parameters, where communicating during the rTWT SP of the second wireless device is in accordance with the received beacon.

Aspect 59: The non-transitory computer-readable medium of any of aspects 57 through 58,wherein the code to receive the one or more EDCA parameters are executable by the one or more processors to: receive, from the second wireless device, an advertisement of the rTWT SP of the second wireless device, where the advertisement associates the one or more EDCA parameters with the first wireless device with respect to the rTWT SP of the second wireless device.

Aspect 60: The non-transitory computer-readable medium of aspect 59, where the advertisement of the rTWT SP of the second wireless device further associates one or more additional EDCA parameters with a fourth wireless device with respect to the rTWT SP of the second wireless device.

Aspect 61: The non-transitory computer-readable medium of any of aspects 57 through 60, where a use of the one or more EDCA parameters by the first wireless device during the rTWT SP of the second wireless device is conditioned on an orthogonality between the rTWT SP of the second wireless device and an rTWT SP of the first wireless device.

Aspect 62: The non-transitory computer-readable medium of any of aspects 57 through 61, where communicating during the rTWT SP of the second wireless device according to the one or more EDCA parameters is in accordance with an orthogonality between the rTWT SP of the second wireless device and an rTWT SP of the first wireless device.

Aspect 63: The non-transitory computer-readable medium of any of aspects 57 through 62,wherein the code to receive the one or more EDCA parameters are executable by the one or more processors to: receive one or more rTWT negotiation messages from the second wireless device, the one or more RTWT negotiation messages including the one or more EDCA parameters associated with the rTWT SP of the second wireless device.

Aspect 64: The non-transitory computer-readable medium of aspect 63, where the instructions are further executable by the one or more processors to: transmit one or more rTWT negotiation messages to the second wireless device, the one or more rTWT negotiation messages including one or more EDCA parameters associated with a rTWT SP of the first wireless device.

Aspect 65: The non-transitory computer-readable medium of any of aspects 57 through 64, where the first wireless device is a first wireless AP, and the second wireless device is a second wireless AP.

Aspect 66: The non-transitory computer-readable medium of any of aspects 57 through 65, where the first wireless device is a wireless STA, and the second wireless device is a wireless AP.

Aspect 67: A non-transitory computer-readable medium storing code for wireless communication, the code including instructions executable by one or more processors to: transmit, to a second wireless device, one or more first EDCA parameters associated with a rTWT SP of the first wireless device; and communicate with one or more third wireless devices during the rTWT SP of the first wireless device according to one or more second EDCA parameters associated with the first wireless device, the one or more second EDCA parameters being different from the one or more first EDCA parameters.

Aspect 68: The non-transitory computer-readable medium of aspect 67,wherein the code to transmit the one or more first EDCA parameters are executable by the one or more processors to: broadcast a beacon including the one or more first EDCA parameters.

Aspect 69: The non-transitory computer-readable medium of any of aspects 67 through 68,wherein the code to transmit the one or more first EDCA parameters are executable by the one or more processors to: transmit an advertisement of the rTWT SP of the first wireless device, where the advertisement associates the one or more first EDCA parameters with the second wireless device with respect to the rTWT SP of the first wireless device.

Aspect 70: The non-transitory computer-readable medium of aspect 69, where the advertisement of the rTWT SP of the first wireless device further associates one or more third EDCA parameters with a fourth wireless device with respect to the rTWT SP of the first wireless device.

Aspect 71: The non-transitory computer-readable medium of any of aspects 67 through 70,wherein the code to transmit the one or more EDCA parameters are executable by the one or more processors to: transmit one or more rTWT negotiation messages to the second wireless device, the one or more rTWT negotiation messages including the one or more first EDCA parameters associated with the rTWT SP of the first wireless device.

Aspect 72: The non-transitory computer-readable medium of aspect 71, where the instructions are further executable by the one or more processors to: receive one or more rTWT negotiation messages from the second wireless device, the one or more rTWT negotiation messages including an indication of one or more EDCA parameters associated with a rTWT SP of the second wireless device.

Aspect 73: The non-transitory computer-readable medium of any of aspects 67 through 72, where the first wireless device is a first wireless AP, and the second wireless device is a second wireless AP.

Aspect 74: The non-transitory computer-readable medium of any of aspects 67 through 73, where the first wireless device is a wireless AP, and the second wireless device is a wireless STA.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive one or more enhanced distributed channel access (EDCA) parameters associated with a restricted target wakeup time (rTWT) service period (SP) of a second wireless device; and
communicate with one or more third wireless devices during the rTWT SP of the second wireless device according to the one or more EDCA parameters.

2. The first wireless device of claim 1, wherein, to receive the one or more EDCA parameters, the processing system is configured to cause the first wireless device to:
receive, from the second wireless device, a beacon that includes the one or more EDCA parameters, wherein communicating during the rTWT SP of the second wireless device is in accordance with the received beacon.

3. The first wireless device of claim 1, wherein, to receive the one or more EDCA parameters, the processing system is configured to cause the first wireless device to:
receive, from the second wireless device, an advertisement of the rTWT SP of the second wireless device, wherein the advertisement associates the one or more EDCA parameters with the first wireless device with respect to the rTWT SP of the second wireless device.

4. The first wireless device of claim 3, wherein the advertisement of the rTWT SP of the second wireless device further associates one or more additional EDCA parameters with a fourth wireless device with respect to the rTWT SP of the second wireless device.

5. The first wireless device of claim 1, wherein a use of the one or more EDCA parameters by the first wireless device during the rTWT SP of the second wireless device is conditioned on an orthogonality between the rTWT SP of the second wireless device and an rTWT SP of the first wireless device.

6. The first wireless device of claim 1, wherein communicating during the rTWT SP of the second wireless device according to the one or more EDCA parameters is in accordance with an orthogonality between the rTWT SP of the second wireless device and an rTWT SP of the first wireless device.

7. The first wireless device of claim 1, wherein, to receive the one or more EDCA parameters, the processing system is configured to cause the first wireless device to:
receive one or more rTWT negotiation messages from the second wireless device, the one or more RTWT negotiation messages including the one or more EDCA parameters associated with the rTWT SP of the second wireless device.

8. The first wireless device of claim 7, wherein the processing system is further configured to cause the first wireless device to:
transmit one or more rTWT negotiation messages to the second wireless device, the one or more rTWT negotiation messages including one or more EDCA parameters associated with a rTWT SP of the first wireless device.

9. The first wireless device of claim 1, wherein the first wireless device is a first wireless access point (AP), and the second wireless device is a second wireless AP.

10. The first wireless device of claim 1, wherein the first wireless device is a wireless station (STA), and the second wireless device is a wireless access point (AP).

11. A first wireless device, comprising:
a processing system that includes processor circuitry and memory circuitry that stores code, the processing system configured to cause the first wireless device to:
transmit, to a second wireless device, one or more first enhanced distributed channel access (EDCA) parameters associated with a restricted target wakeup time (rTWT) service period (SP) of the first wireless device; and
communicate with one or more third wireless devices during the rTWT SP of the first wireless device according to one or more second EDCA parameters associated with the first wireless device, the one or more second EDCA parameters being different from the one or more first EDCA parameters.

12. The first wireless device of claim 11, wherein, to transmit the one or more first EDCA parameters, the processing system is configured to cause the first wireless device to:
broadcast a beacon including the one or more first EDCA parameters.

13. The first wireless device of claim 11, wherein, to transmit the one or more first EDCA parameters, the processing system is configured to cause the first wireless device to:
transmit an advertisement of the rTWT SP of the first wireless device, wherein the advertisement associates the one or more first EDCA parameters with the second wireless device with respect to the rTWT SP of the first wireless device.

14. The first wireless device of claim 11, wherein communicating during the rTWT SP of the first wireless device according to the one or more second EDCA parameters is in accordance with an orthogonality between the rTWT SP of the first wireless device and an rTWT SP of the second wireless device.

15. A method for wireless communication by a first wireless device, comprising:
receiving one or more enhanced distributed channel access (EDCA) parameters associated with a restricted target wakeup time (rTWT) service period (SP) of a second wireless device; and
communicating with one or more third wireless devices during the rTWT SP of the second wireless device according to the one or more EDCA parameters.

16. The method of claim 15, wherein receiving the one or more EDCA parameters comprises:
receiving, from the second wireless device, a beacon that includes the one or more EDCA parameters, wherein communicating during the rTWT SP of the second wireless device is in accordance with the received beacon.

17. The method of claim 15, wherein receiving the one or more EDCA parameters comprises:
receiving, from the second wireless device, an advertisement of the rTWT SP of the second wireless device, wherein the advertisement associates the one or more EDCA parameters with the first wireless device with respect to the rTWT SP of the second wireless device.

18. The method of claim 17, wherein the advertisement of the rTWT SP of the second wireless device further associates one or more additional EDCA parameters with a fourth wireless device with respect to the rTWT SP of the second wireless device.

19. The method of claim 15, wherein a use of the one or more EDCA parameters by the first wireless device during the rTWT SP of the second wireless device is conditioned on an orthogonality between the rTWT SP of the second wireless device and an rTWT SP of the first wireless device.

20. The method of claim 15, wherein communicating during the rTWT SP of the second wireless device according to the one or more EDCA parameters is in accordance with an orthogonality between the rTWT SP of the second wireless device and an rTWT SP of the first wireless device.
